(19) United States
(12) Patent Application Publication
(10) Pub. No.: US 2025/0044870 A1
(43) Pub. Date: Feb. 6, 2025

(54) METHOD FOR CONTROLLING A PLURALITY OF HAPTIC ACTUATORS

(71) Applicant: ACTRONIKA, PARIS (FR)

(72) Inventors: Hugo BOUCHARD, VINCENNES (FR); Thomas BEGEOT, PARIS (FR); Sylvain GAULTIER, PARIS (FR); Jérémy CHEYNET, SAINT MATHIEU DE TREVIERS (FR)

(21) Appl. No.: 18/697,222

(22) PCT Filed: Sep. 29, 2022
(86) PCT No.: PCT/EP2022/077201

§ 371 Date: Mar. 29, 2024

(30) Foreign Application Priority Data
Oct. 1, 2021 (FR) FR2110424

(51) Int. Cl. G06F 3/01

(52) U.S. Cl. CPC G06F 3/016

(57) ABSTRACT

A method for simultaneously controlling in real time a plurality of haptic actuators by haptic controllers, each haptic controller being associated with one haptic actuator of the haptic actuators, the method including receiving a sampled digital signal including a plurality of samples, each sample including a control value per haptic controller of the plurality of haptic controllers; for each sample, simultaneously extracting, by each haptic controller, the corresponding control value included in the sample; controlling the haptic actuators by the haptic controllers, the controlling including, for each haptic controller: converting, by the haptic controller, the control value extracted into an activation signal for activating the corresponding haptic actuator; transmitting the activation signal to the corresponding haptic actuator.

### TECHNICAL FIELD OF THE INVENTION

The technical field of the invention is that of haptic devices and, more particularly that of controlling haptic devices.

The present invention relates to a method for simultaneously controlling a plurality of haptic actuators in real time. The present invention also relates to a device, a system and a computer program product for implementing the method according to the invention.

### TECHNOLOGICAL BACKGROUND OF THE INVENTION

Virtual reality is being developed and popularised in a large number of fields, especially video games, medicine and aeronautics. Virtual reality headsets take advantage of the stereoscopic function of human vision to offer three-dimensional audiovisual immersion in a video game, for example, enabling users to interact with the environment around them. Despite the impression of immersion offered by virtual reality headsets, the potential of virtual reality is not fully exploited and immersion remains incomplete due to the absence of convincing haptic feedback so that a user can feel physical stimuli that replace and/or accompany their audiovisual experience.

There are haptic feedback systems that allow the user to feel objects virtually touched, for example haptic gloves, which produce tactile sensations when a user wishes to grasp a virtual object.

However, tactile sensations are only perceived superficially during immersion in virtual reality. In fact, virtual reality haptic devices suffer from low fidelity of the vibrotactile actuators commonly used and do not produce a credible haptic illusion.

There is a need to improve the sensations of a user during a virtual reality experience in order to get closer to the sensations felt when the same experience is had in real life.

### SUMMARY OF THE INVENTION

The invention offers a solution to the problems previously discussed, by making it possible to simultaneously control a plurality of actuators by varying the vibration activation signal output by the actuators in an arbitrary manner over time and with low latency to obtain a haptic experience that accurately simulates the sensations felt during a corresponding real experience.

One aspect of the invention relates to a method for simultaneously controlling in real-time a plurality of haptic actuators by a plurality of haptic controllers, each haptic controller being associated with a haptic actuator of the plurality of haptic actuators, the method comprising the following steps:
Receiving a sampled digital signal comprising a plurality of samples, each sample comprising a control value per haptic controller of the plurality of haptic controllers
For each sample, simultaneously extracting, by each haptic controller, the corresponding control value included in the sample;
Controlling the plurality of haptic actuators by the plurality of haptic controllers, the controlling step comprising the following sub-steps for each haptic controller:
   Converting by the haptic controller the extracted control value into an activation signal for activating the corresponding haptic actuator;
   Transmitting the activation signal to the corresponding haptic actuator.

By virtue of the invention, a plurality of haptic actuators are simultaneously controlled, by virtue of a sampled digital signal received. Each sample of the sampled digital signal received comprises data for controlling each haptic actuator to be controlled synchronously in terms of value and varying the vibration waveform of the haptic actuators over a wide range of frequencies (for example between 0 and 1000 Hz), unlike haptic actuators of the state of the art which often have only an inactivated state or an activated state in which they vibrate according to a law dictated by their intrinsic response to an all-or-nothing activation signal. Thus, the different waveforms reproduced by each actuator make it possible to simulate realistic sensations during a virtual reality experience.

Further to the characteristics just discussed in the preceding paragraph, the method according to the invention may have one or more additional characteristics from among the following, considered individually or according to any technically possible combinations: A step of storing the received digital signal in a buffer memory, carried out before the extracting step.
The digital signal received is stored in the buffer memory in form of an array, each row of which corresponds to a sample and each column of which corresponds to a haptic actuator, each control value included in the digital signal received being stored at the row and at the column of the corresponding array.
The step of controlling the plurality of haptic actuators is only carried out if the buffer memory comprises a number of data greater than or equal to a predetermined threshold.
The method further comprises a step of resampling the digital signal received, performed before the extracting step.
The resampling step is performed using a sampling ratio equal to the ratio of a sampling frequency of the digital signal received to an output sampling frequency.
When the digital signal is received according to the USB© protocol, the sampling ratio is recalculated after a defined period of time.
The digital signal received is a digital audio signal. Transmission of a digital audio signal is an advantageous characteristic because the control device can be regarded as a sound card and therefore use any known digital audio signal processing software capable of controlling a multi-channel interface, the processing software being Reaper, Max/MSP or Cubase, for example.
The digital signal received is received according to the USB©, Wifi© or Ethernet© protocol.

Another aspect of the invention relates to a control device configured to implement the method according to the invention, comprising at least one microcontroller comprising at least one memory, a processor and a plurality of haptic controllers.

The invention also relates to a haptic system comprising:
A plurality of haptic actuators to be controlled,
The control device according to the invention, configured to control the plurality of haptic actuators.

The haptic system may further comprise an operating device configured to send the digital signal to the control device.

Another aspect of the invention relates to a computer program product comprising instructions which, when the program is executed by a computer, cause the same to implement the steps of the method for simultaneously controlling a plurality of haptic actuators.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a block diagram of a control method according to the invention.

FIG. 2 is a schematic representation of a control device according to the invention.

FIG. 3 is a schematic representation of a haptic system according to the invention.

### DETAILED DESCRIPTION

The figures are set forth by way of indicating and in no way limiting purposes of the invention.

Unless otherwise specified, a same element appearing in different figures has a single reference.

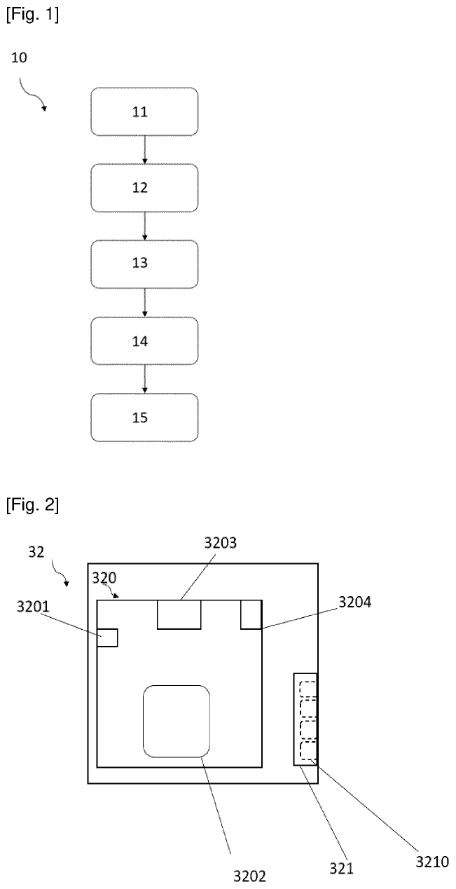

A first aspect of the invention relates to a method 10 for simultaneously controlling in real time a plurality of haptic actuators by a plurality of haptic actuator controllers, the steps of which are represented in the block diagram of [FIG. 1].

A second aspect of the invention relates to a control device 32 for implementing the method 10 according to the invention, schematically represented in [FIG. 2].

The control device 32 comprises a power stage 321 integrating the plurality of haptic controllers 3210 and at least one microcontroller 320 comprising at least a memory 3203 and a processor 3202.

The haptic controllers 3210 of the control device 32 may be H-bridges or digital audio amplifiers.

Examples of haptic controllers 3210 may include the STSPIN240 or STSPIN250 haptic controller, the MAX98357 haptic controller, or the TAS6421-01 haptic controller.

The haptic controllers 3210 may, for example, take as an input digital signals in PCM (Pulse Code Modulation) format.

The control device 32 may be, for example, an electronic control card.

The control device 32 comprises, for example, a serial bus type electric card according to the 12S standard or a Pulse Width Modulation (PWM) module included in the microcontroller 320, for controlling the power stage 321.

Each haptic controller 3210 is associated with one haptic actuator of the plurality of haptic actuators. Thus, the number of haptic controllers 3210 of the plurality of haptic controllers 3210 is equal to the number of haptic actuators included in the plurality of haptic actuators.

A first step of the method 10 is a step of receiving 11 a sampled digital signal comprising a plurality of samples.

Each sample of the sampled digital signal comprises a control value per haptic controller 3210 of the plurality of haptic controllers 3210.

According to one embodiment, the digital signal received may be a digital audio signal, for example encoded in PCM16 format, i.e. comprising data whose values are coded on two bytes and preferably included in the interval [−32768; +32767]. The PCM16 format makes it possible to improve haptic accuracy of the plurality of haptic actuators, with respect to some formats of the state of the art.

The control value may be zero, or the digital representation of a signed real or integer value. In the embodiment wherein the received digital signal is in PCM16 format, the control value may be the digital representation of a 16-bit signed integer, and thus included in the interval [−32768; 32767].

In the embodiment wherein the power stage 321 is controlled by a PWM module, each control value comprises at least two data including a first piece of data for determining a duty cycle of a control voltage of the corresponding haptic controller 3210 and a second piece of data for determining the phase of said control voltage.

The digital signal may be received according to a wired protocol, for example the USB© or Ethernet© communication protocol, or according to a wireless protocol, for example the Wifi© communication protocol.

A sampling frequency of the digital signal received may be equal to 44.1 kHz.

The method 10 may further comprise a second step of resampling 12 the digital signal received.

Indeed, the sampling frequency may fluctuate according to the temperature of the microcontroller 302 or the surrounding temperature, which may require, according to the communication protocol, implementation of a resampling step 12.

The second step 12 is performed, for example, using a resampling ratio, preferably equal to the ratio of the sampling frequency of the digital signal received to an output sampling frequency.

The output sampling frequency is preferably compatible with a frequency of an input signal to the power stage 321, included a range of input frequencies specified by the manufacturer of the power stage 321.

When the power stage 321 is controlled by a PWM module, the output sampling frequency depends, for example, on the selected number of bits of precision and the PWM module clock in the microcontroller 320.

For example, if the clock frequency of the PWM module is 150 MHz and 16 bits of precision are desired (2¹⁶=65536 possible values), then 150 MHz=150000000 Hz should be divided by 65536 to obtain an output sampling frequency which herein is 150 000 000/65536=2288.9 Hz.

For example, if the PWM module clock frequency is 150 MHz and 16 bits of precision are required (2¹⁶=65536 possible control values, the values being signed), the control values are included in the range: [−32768; 32767]. In this case, the output sampling frequency is 150 000 000/32768=4577.6 Hz.

The output sampling frequency should also be chosen to be at least twice the maximum frequency of the digital signal received by the control device 32 in order to comply with the Shannon criterion.

The sampling ratio is for example recalculated after a defined period of time, for example one second, for example when the digital signal is received according to the USB© communication protocol.

At the end of the resampling step 12, a digital signal resampled is obtained, the frequency of which is equal to the output sampling frequency.

The method 100 may comprise a third step of storing 13 the digital signal received in a buffer memory, preferably a circular buffer memory.

Preferably, the digital signal received stored in the buffer memory is the digital signal resampled. In this case, the resampling ratio makes it possible to manage the data flow received by the buffer memory, in order to prevent data entering the buffer memory from having an input speed lower or higher than an output speed of data included in the buffer memory.

According to one embodiment, the buffer memory comprises a two-dimensional array, each row of which corresponds to a sample and each column of which corresponds to a haptic actuator, storing each control value included in the digital signal received at the row and column of the corresponding array.

For example, if the received digital signal is coded in PCM16 format and the number of haptic actuators to be controlled is equal to five, each haptic actuator being numbered from 1 to 5, an example of an array included in the buffer, for four samples, may be the following array:

| | Actuator | | | | |
|---|---|---|---|---|---|
| Sample | 1 | 2 | 3 | 4 | 5 |
| Sample 1 | 0 | −9500 | 2000 | 0 | 31620 |
| Sample 2 | 0 | −11002 | 3507 | 0 | 31600 |
| Sample 3 | 10 | −15305 | 5068 | 0 | 30500 |
| Sample 4 | 200 | −16500 | 5602 | 0 | 30000 |

The method 10 further comprises a fourth step 14 for each sample, of simultaneously extracting, by each haptic controller 3210, the corresponding control value included in the sample.

More precisely, each control value is periodically read by the corresponding haptic controller 3210 in each sample at a period equal to the inverse of the sampling frequency of the digital signal received if the second step 12 is not performed and to the output sampling frequency if the second step 12 is performed.

The method 10 further comprises a fifth step of controlling 15 the plurality of haptic actuators by the plurality of haptic controllers 3210.

The fifth step comprises a first sub-step of converting, by each haptic controller 3210, the corresponding control value into a signal for activation of the corresponding haptic actuator.

In the embodiment wherein the power stage 321 is controlled by a PWM module and wherein the digital signal received is coded in PCM16 format, i.e. wherein the control values are included in the range [−32768; +32767], a duty cycle of the control voltage of a corresponding haptic controller 3210 depends on the control value, for example the absolute value of the control value, of said haptic controller included in a given sample, and the voltage operating range of said haptic controller 3210.

For example, if said haptic controller 3210 operates for a control voltage between 0 and 10 V, then for a given sample of the sampled received digital signal or the resampled received digital signal, the absolute value of the control value being 0 corresponds to a duty cycle of 0% and a control voltage of 0 V and a control value being 32767 corresponds to a duty cycle of 100% and a control voltage of 10 volts. Thus, a cross multiplication can be used to determine a control voltage for the haptic controller 3210, for example a control value equal to 25000 corresponds to a duty cycle of (25000/32767)*100%=76% and a control voltage equal to 0.76*10=7.6 volts.

In the embodiment wherein the power stage 321 is controlled by a PWM module and wherein the digital signal received is coded in PCM16 format, i.e. wherein the control values are included in the interval [−32768; +32767], a phase of the control voltage of a corresponding haptic controller 3210 depends on the sign of the control value of said haptic controller 3210 included in a given sample. For example, a positive sign of the control value corresponds to a negative phase of the control voltage of said haptic controller 3210 and a negative sign corresponds to a negative phase of the control voltage of said haptic controller.

Each haptic controller 3210 then generates an activation signal for the corresponding haptic actuator 33, for example an electric current, which depends on the control voltage obtained by the haptic controller 3210 and therefore on the control value associated with the haptic controller 3210.

The fifth step comprises a second sub-step of transmitting each activation signal to the corresponding haptic actuator.

Each haptic actuator then receives the activation signal sent by the corresponding haptic controller 3210, which it converts into mechanical movements that depend on the intensity of the activation signal received.

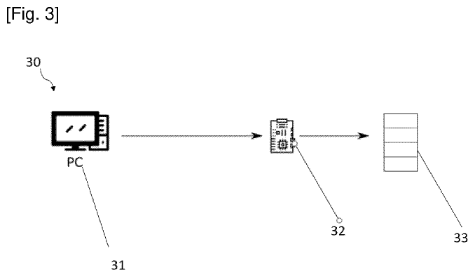

The activation signal allows the vibration waveform of the haptic actuator to be varied within an operating frequency range of the haptic actuator. For example, an operating frequency range of a haptic actuator may be [0 Hertz; 1000 Hertz].

[FIG. 3] shows a haptic system 300 comprising the control device 32 and a plurality of haptic actuators 33 to be controlled.

The haptic system 30 may also comprise an operating device 31 configured to send digital signals to the control device 32. The operating device 31 may be a computer for example.

The digital signals sent by the operating device 31 are received by the control device 32 represented in more detail in [FIG. 2]. The microcontroller 302 of the control device 32 may then comprise at least one port 3201, for example a USB © or Ethernet © port and a wired and/or wireless network interface 3204. In the case of a non-wired network interface, of the Wifi™ type, a radio module (Wifi™ and/or Bluetooth™ for example) may be integrated into the microcontroller 302 (MCU for Microcontroller Unit) or be external to the microcontroller 302. In this case, a communication interface such as SDIO or PCle provides the link between the radio module and the microcontroller 302.

According to one embodiment, the operating device 31 and the control device 32 are preferably connected via the USB © standard and preferably the USB 2.0 © standard. In this embodiment, data transfer between the operating device 31 and the control device 32 may be of the isochronous type and a data reception rate D may be 8192 bytes per millisecond, for example. The isochronous type of data transfer advantageously makes it possible to reduce latency time between emission of the digital signal by the operating device and reception of the signal by the control device, which enables a user to improve their virtual reality experience and to have a low latency between the user's viewing and perception. Advantageously, the latency time between emission of a signal by the operating device and reception of said signal by the control device is less than 20 milliseconds, for example less than 15 milliseconds and is preferably equal to 7 milliseconds.

The term isochronous can be used for communications with sending periodic data, such as communications via the USB © standard. However, other networks (wired or not) which support protocols implementing the time synchronisation of nodes as well as bandwidth reservation as a function of traffic priority for a given time and period can also be assimilated to the term isochronous. They also provide for the periodic sending of data and are therefore deterministic like USB.

An example of a wired network that implements time synchronisation between nodes is the AVB (Audio Video Bridging) protocol on an Ethernet network.

An example of a wireless network is the WI-FI™ network. In particular, the protocol used for the WI-FI™ network should implement the IEEE 1588 standard or IEEE 802.1AS standard which defines node synchronisation. These standards are used in AVB (Audio Video Bridging) and TSN (Time Sensitive Network), for example.

Other protocols used for streaming (i.e. for viewing and/or listening to content while connected to the Internet, for example) implement asynchronous transmission algorithms based solely on the priority of the frames to be transmitted. To avoid having to store low-priority frames for too long, a priority scheduling mechanism is implemented. Several mechanisms exist but are implemented by limiting the bandwidth with a leaky bucket. This leaky bucket induces some periodicity in sending frames and provides high level of determinism, which means that these protocols can also be likened to the term isochronous.

According to another embodiment in which the control device 32 comprises a wired network interface 3204, the control device 32 communicates with the operating device 31 preferably via the Ethernet© protocol.

According to another embodiment wherein the control device 32 comprises a non-wired network interface 3204, the control device 32 communicates with the operating device 31 via the Wifi© standard for example.

The haptic actuators 33 may be Voice Coil Actuators or preferably Linear Resonance Actuators.

In the embodiment wherein the haptic actuators 33 are linear resonance actuators, each linear resonance actuator comprises a movable mass, translating along an axis, the direction and amplitude of displacement of which may depend on the phase and mean value of the activation signal received respectively.

The haptic actuators 33 are preferably chosen with a wide bandwidth, wherein the frequency range of vibrations generated by said haptic actuators can, for example, be included in or equal to the interval [0 Hertz; 1000 Hertz].

The number of haptic actuators 33 of the plurality of simultaneously controllable haptic actuators 303 is for example equal to the ratio of the data reception rate D by the control device 32 to the number of data bytes per millisecond sent to a haptic controller 3210.

The number of bytes of data sent to a haptic controller 3210 is equal to the sampling frequency of the digital signal received by the control device 32, multiplied by the number of bytes used to code the digital signal received.

According to the embodiment in which the data reception rate D by the control device 32 is 8192 bytes per millisecond, and according to one embodiment in which the sampling frequency of the digital signal received by the control device 32 is 44.1 kHz=44100 Hz=44.1 ms⁻¹ and in which the digital signal received is in PCM16 format and is encoded on two bytes, the number of simultaneously controllable haptic actuators 33 is 8192/(44.1×2)=92 haptic actuators 33.

The haptic actuators 33 to be controlled can be embedded in a jacket, allowing a user to feel same sensations as a video game character, for example a shooting impact.

The haptic actuators 33 to be controlled can also be embedded in cinema seats in order to improve the comfort of viewers and provide them with the same sensations as those felt by the characters in a film.

The haptic actuators 33 to be controlled can also be embedded in haptic seats or motorbike helmets.

1. A method for simultaneously controlling in real time a plurality of haptic actuators by a plurality of haptic controllers, each haptic controller being associated with one haptic actuator of the plurality of haptic actuators, the plurality of haptic controllers being integrated into a control device, the method comprising:
receiving, by the control device, a sampled digital signal emitted by an operating device, the digital signal comprising a plurality of samples, each sample comprising a control value per haptic controller of the plurality of haptic controllers, a data transfer between the operating device and the control device-being of isochronous type;
for each sample, simultaneously extracting, by each haptic controller, the corresponding control value included in the sample;
controlling the plurality of haptic actuators by the plurality of haptic controllers, the controlling comprising the following sub-steps for each haptic controller:
converting, by the haptic controller, the control value extracted into an activation signal for activating the corresponding haptic actuator;
transmitting the activation signal to the corresponding haptic actuator.

2. The method according to claim 1, further comprising storing the digital signal received in a buffer memory, performed prior to the extracting.

3. The method according to claim 2, wherein the digital signal received is stored in the buffer memory in form of an array, each row of which corresponds to a sample and each column of which corresponds to a haptic actuator, each control value included in the digital signal received being stored at the row and at the column of the corresponding array.

4. The method according to claim 2, wherein the controlling of the plurality of haptic actuators is performed only if the buffer comprises a number of data greater than or equal to a predetermined threshold.

5. The method according to claim 1, further comprising resampling the digital signal received, performed before the extracting.

6. The method according to claim 5, wherein the resampling is performed using a sampling ratio equal to the ratio of a sampling frequency of the digital signal received to an output sampling frequency.

7. The method according to claim 5, wherein when the digital signal is received according to the USB© protocol, the sampling ratio is recalculated after a defined period of time.

8. The method according to claim 1, wherein the digital signal received is a digital audio signal.

9. The method according to claim 1, wherein the digital signal received is received according to the USB©, WiFi© or Ethernet© protocol.

10. A control device configured to implement the method according to claim 1, comprising at least one microcontroller comprising at least one memory, a processor and a plurality of haptic controllers-.

11. A haptic system comprising:
a plurality of haptic actuators to be controlled;
the control device according to claim 10, configured to control the plurality of haptic actuators.

12. The haptic system according to claim 11, further comprising an operating device configured to send the digital signal to the control device.

13. A non-transitory computer readable medium comprising instructions which, when the instructions are executed by a computer, cause the same to implement the method according to claim 1.
